(19) United States
(12) Patent Application Publication
(10) Pub. No.: US 2024/0115998 A1
(43) Pub. Date: Apr. 11, 2024

(54) GASOLINE ENGINE EXHAUST GAS PURIFYING CATALYST FILTER

(71) Applicants: HONDA MOTOR CO., LTD., Minato-ku (JP); N.E. CHEMCAT CORPORATION, Minato-ku (JP)

(72) Inventors: Takeshi MORI, Minato-ku (JP); Shinichiro OTSUKA, Minato-ku (JP); Yoshiaki HATAKEYAMA, Minato-ku (JP); Mahiro SHIROTORI, Minato-ku (JP)

(73) Assignees: HONDA MOTOR CO., LTD., Minato-ku (JP); N.E. CHEMCAT CORPORATION, Minato-ku (JP)

(21) Appl. No.: 18/263,646

(22) PCT Filed: Jan. 26, 2022
(86) PCT No.: PCT/JP2022/002943

§ 371 Date: Jul. 31, 2023

(30) Foreign Application Priority Data
Feb. 1, 2021 (JP) 2021-014372

(51) Int. Cl. B01D 53/94; B01J 21/04; B01J 21/06; B01J 23/10; B01J 23/44; B01J 23/46; B01J 35/57; B01J 37/02; B01J 37/04; B01J 37/08; F01N 3/022

(52) U.S. Cl. CPC B01D 53/945; B01J 21/04; B01J 21/066; B01J 23/10; B01J 23/44; B01J 23/464; B01J 35/57; B01J 37/0242; B01J 37/04; B01J 37/08; F01N 3/0222; B01D 2255/1023; B01D 2255/1025; B01D 2255/2063; B01D 2255/407; B01D 2255/908; B01D 2255/9155; B01D 2257/404; B01D 2257/502; B01D 2257/702; B01D 2258/012

(57) ABSTRACT

It is an object of the present invention to provide an exhaust gas purifying catalyst filter which has enhanced soot collection performance without increasing pressure loss caused by the formation of a catalyst layer in a partition wall of a wall flow type substrate.

A gasoline engine exhaust gas purifying catalyst filter for purifying exhaust gas of a gasoline engine includes: a wall flow type substrate in which an introduction-side cell having an open exhaust gas introduction-side end, and a discharge-side cell adjacent to the introduction-side cell and having an open exhaust gas discharge-side end are defined by a porous partition wall; and a catalyst layer formed in a pore of the partition wall. An absolute value of a maldistribution degree of the catalyst layer formed in the pore of the partition wall is 4.50 or less. A wash coat amount, excluding a mass of a platinum group, of the catalyst layer formed in the pore of the partition wall, is 40 g/L or more and 50 g/L or less. The catalyst layer formed in the pore of the partition wall is a single layer. The catalyst layer is free of Ba.

### TECHNICAL FIELD

The present invention relates to a gasoline engine exhaust gas purifying catalyst filter.

### BACKGROUND ART

A particulate material (PM) mainly containing carbon, and ash composed of incombustible components, and the like are contained in exhaust gas discharged from an internal combustion engine. The exhaust gas is known to cause air pollution. In a diesel engine relatively readily discharging a particulate material as compared with a gasoline engine, the amount of the particulate material discharged has been severely regulated. In recent years, also in the gasoline engine, the regulation of the amount of the particulate material discharged has been tightened.

A method in which a particulate filter is provided on an exhaust gas passage of an internal combustion engine in order to deposit and collect a particulate material has been known as means for reducing the amount of the particulate material discharged. In particular, in recent years, from the viewpoint of the space saving of a mounting space, and the like, in order to simultaneously achieve the suppression of the emission of the particulate material and the removal of harmful components such as carbon monoxide (CO), hydrocarbon (HC), and nitrogen oxide (NOₓ), a catalyst slurry is considered to be coated on the particulate filter, followed by firing, to provide a catalyst layer.

A particulate filter has a wall flow type substrate in which an introduction-side cell having an open exhaust gas introduction-side end and a discharge-side cell adjacent to the introduction-side cell and having an open exhaust gas discharge-side end are defined by a porous partition wall. A known method for forming the above-described catalyst layer on such a particulate filter involves regulating penetration of a catalyst slurry into the partition wall by regulating properties such as viscosity and solid content of the slurry and pressurizing either the introduction-side cell or the discharge-side cell to create a pressure difference between the introduction-side cell and the discharge-side cell (see, for example, Patent Literature 1).

### CITATION LIST

### Patent Literature

Patent Literature 1: WO2016/060048

### SUMMARY OF INVENTION

### Technical Problem

The particulate filter as described in Patent Literature 1 has a wall flow type structure from the viewpoint of removing a particulate material, and is configured such that exhaust gas passes through a pore of the partition wall. However, there is still room for improvement in soot collection performance.

The present invention has been made in view of the foregoing problems, and an object of the present invention is to provide an exhaust gas purifying catalyst filter which has enhanced soot collection performance without increasing pressure loss caused by the formation of a catalyst layer in a partition wall of a wall flow type substrate. The exhibition of operations and effects which are derived from each configuration shown in the Description of Embodiments to be described later, and are not obtained by a conventional technique without being limited to the object here can also be positioned as another object of the present invention.

### Solution to Problem

The present inventors have conducted continuous and intensive studies on a method for enhancing soot collection performance without increasing pressure loss caused by the formation of a catalyst layer in a partition wall of a wall flow type substrate. As a result, the present inventors have found that an increase in pressure loss is suppressed and soot collection performance is improved by adjusting the maldistribution degree of the catalyst layer to be formed in the partition wall of the wall flow type substrate, and the wash coat amount of the catalyst layer to be applied, and thus have accomplished the present invention. That is, the present invention provides various specific aspects to be described later.

[1]

A gasoline engine exhaust gas purifying catalyst filter for purifying exhaust gas of a gasoline engine, including:
a wall flow type substrate in which an introduction-side cell having an open exhaust gas introduction-side end, and a discharge-side cell adjacent to the introduction-side cell and having an open exhaust gas discharge-side end are defined by a porous partition wall; and
a catalyst layer formed in a pore of the partition wall,
wherein an absolute value of a maldistribution degree of the catalyst layer formed in the pore of the partition wall is 4.50 or less;
a wash coat amount, excluding a mass of a platinum group, of the catalyst layer formed in the pore of the partition wall is 40 g/L or more and 50 g/L or less;
the catalyst layer formed in the pore of the partition wall is a single layer; and
the catalyst layer is free of Ba.
   [2]

The gasoline engine exhaust gas purifying catalyst filter according to [1],
wherein the catalyst layer formed in the pore of the partition wall contains a catalyst metal and a carrier component; the catalyst metal is Pd and/or Rh; and the carrier component is Al oxide, Zr oxide, and/or Ce oxide.
   [3]

A method for producing a gasoline engine exhaust gas purifying catalyst filter for purifying exhaust gas of a gasoline engine, the method including:
the step of preparing a wall flow type substrate in which an introduction-side cell having an open exhaust gas introduction-side end, and a discharge-side cell adjacent to the introduction-side cell and having an open exhaust gas discharge-side end are defined by a porous partition wall;
impregnating step of impregnating the exhaust gas introduction-side or exhaust gas discharge-side end of the wall flow type substrate with a catalyst slurry containing ammonium carbonate;
coating step of introducing gas into the wall flow type substrate from a side of the end impregnated with the catalyst slurry to coat the catalyst slurry with which the wall flow type substrate is impregnated on a surface of a pore of the partition wall; and
firing step of firing the coated catalyst slurry to obtain an exhaust gas purifying catalyst filter in which an absolute value of a maldistribution degree of a catalyst layer formed in the pore of the partition wall is 4.50 or less, and a wash coat amount of the catalyst layer, excluding a mass of a platinum group per 1 L of the wall flow type substrate, is 40 g/L or more and 50 g/L or less,
wherein:
the catalyst layer formed in the pore of the partition wall is a single layer; and
the catalyst layer is free of Ba.
   [4]

The method for producing a gasoline engine exhaust gas purifying catalyst filter according to [3], further comprising
the step of measuring the catalyst layer in the pore of the partition wall of the exhaust gas purifying catalyst filter with an electron probe micro analyzer, to inspect the absolute value of the maldistribution degree of the catalyst layer after the firing step of obtaining the exhaust gas purifying catalyst filter.

### Advantageous Effects of Invention

The present invention can provide a gasoline engine exhaust gas purifying catalyst filter which has enhanced soot collection performance without increasing pressure loss. Further improved performance of an exhaust gas treatment system mounted with such a catalyst filter is achieved.

### BRIEF DESCRIPTION OF DRAWINGS

FIG. 1 is a cross-sectional view schematically showing one aspect of an exhaust gas purifying catalyst of the present embodiment.

FIG. 2 shows the maldistribution degrees of catalyst layers of Examples 1 to 3 and Comparative Examples 1 to 3.

FIG. 3 shows the relationships between soot collection rates and pressure losses in Examples 1 to 3 and Comparative Examples 1 to 3.

### DESCRIPTION OF EMBODIMENTS

Hereinafter, an embodiment of the present invention will be described in detail. The following embodiment is one example (representative example) of the embodiment of the present invention, and the present invention is not limited thereto. Modifications of the present invention may be arbitrarily made without departing from the scope thereof. Herein, positional relationships such as upper, lower, left, and right are based on those shown in the drawings unless otherwise specified. The dimensional ratio of the drawings is not limited to the ratio of illustration.

Herein, in the case of the expression with “to” sandwiched between numerical values or physical property values before and after “to”, “to” is used to include the values before and after “to”. For example, the description of the numerical value range “1 to 100” includes both the upper limit value “100” and the lower limit value “1”. The same applies to the description of other numerical value ranges.

### [Exhaust Gas Purifying Catalyst]

An exhaust gas purifying catalyst filter of the present embodiment is an exhaust gas purifying catalyst filter 100 for purifying exhaust gas discharged from a gasoline engine. The exhaust gas purifying catalyst filter 100 includes: a wall flow type substrate 10 in which an introduction-side cell 11 having an open exhaust gas introduction-side end 11a, and a discharge-side cell 12 adjacent to the introduction-side cell 11 and having an open exhaust gas discharge-side end 12a are defined by a porous partition wall 13; and a catalyst layer 21 formed in a pore of the partition wall 13. When the catalyst layer 21 is formed, the maldistribution degree of the catalyst layer is 4.50 or less. The wash coat amount, excluding a mass of a platinum group, of the catalyst layer 21 (hereinafter, also referred to as “WC amount”) is 40 g/L or more and 50 g/L or less. The catalyst layer 21 formed in the pore of the partition wall 13 is a single layer. The catalyst layer 21 is free of Ba.

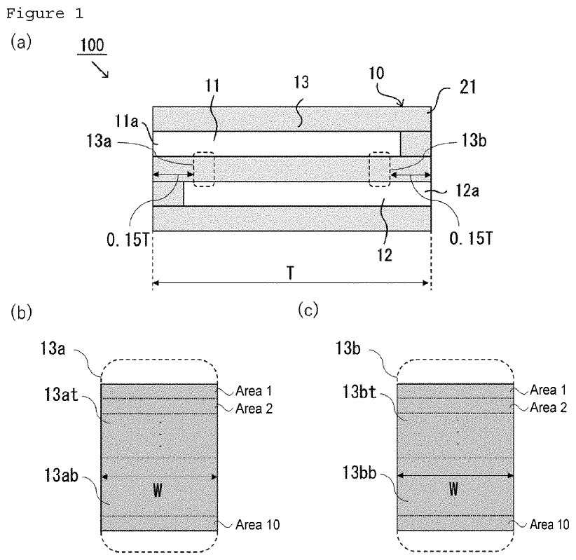

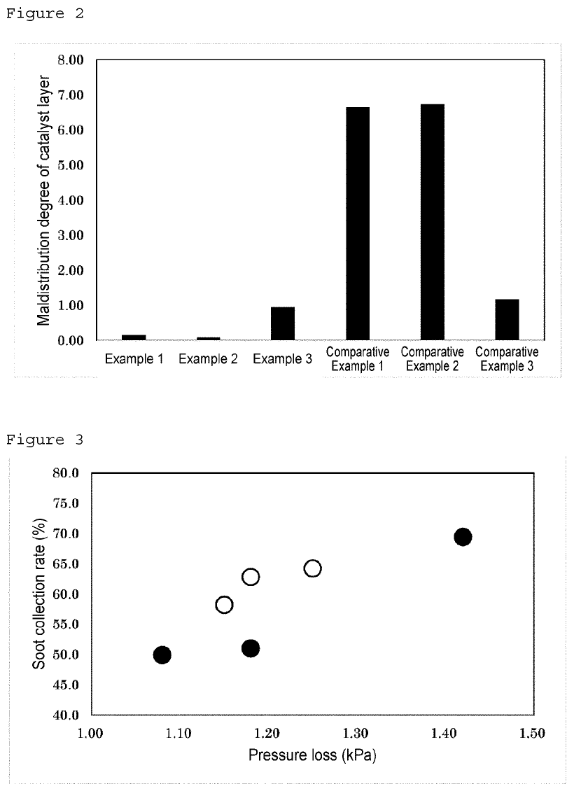

Hereinafter, each constitution will be described with reference to a cross-sectional view showing schematically the exhaust gas purifying catalyst filter of the present embodiment shown in FIG. 1. The exhaust gas purifying catalyst filter of the present embodiment has a wall flow type structure. In the exhaust gas purifying catalyst filter 100 having such a structure, the exhaust gas discharged from the gasoline engine flows into the introduction-side cell 11 from the exhaust gas introduction-side end 11a (open), passes through the pores of the partition wall 13, flows into the adjacent discharge-side cell 12, and flows out of the exhaust gas discharge-side end 12a (open). In this process, a particulate material (PM) which is less likely to pass through the pores of the partition wall 13 is generally deposited on the partition wall 13 and/or in the pores of the partition wall 13 in the introduction-side cell 11. The deposited particulate material is burned and removed by the catalyst function of the catalyst layers 21 or at a predetermined temperature (for example, about 500 to 700° C.). The exhaust gas is brought into contact with the catalyst layers 21 formed in the pores of the partition wall 13. This causes carbon monoxide (CO) and hydrocarbon (HC) contained in the exhaust gas to be oxidized to water (H₂O) or carbon dioxide (CO₂) or the like, causes nitrogen oxide (NOₓ) to be reduced to nitrogen (N₂), and causes harmful components to be purified (detoxified). Herein, removal of the particulate material and purification of the harmful components such as carbon monoxide (CO) are also collectively referred to as “exhaust gas purifying performance.” Hereinafter, each construction will be described in more detail.

### (Maldistribution Degree of Catalyst Layer)

In the present embodiment, the maldistribution degree of the catalyst layer is an index indicative of the distribution of the catalyst layer in the partition wall 13. The maldistribution degree in the present embodiment can be calculated according to the following formulae based on the catalyst layer in each wall measured with an electron probe micro analyzer (hereinafter, also referred to as “EPMA”):

Maldistribution degree=|(in-wall maldistribution degree D1 of catalyst layer in exhaust gas introduction-side portion 13a of partition wall 13)−(in-wall maldistribution degree D2 of catalyst layer in exhaust gas discharge-side portion 13b of partition wall 13)|;

In-wall maldistribution degree D1=(partial maldistribution degree D11 of catalyst in area 13at on side of introduction-side cell 11 in portion 13a)−(partial maldistribution degree D12 of catalyst in area 13ab on side of discharge-side cell 12 in portion 13a);

Partial maldistribution degree D11=sum of local maldistribution degrees of catalyst of areas 1 to 5 among local maldistribution degrees of catalyst in areas 1 to 10 derived by equally dividing portion 13a into ten divided parts;

Partial maldistribution degree D12=sum of local maldistribution degrees of catalyst of areas 6 to 10 among local maldistribution degrees of catalyst in areas 1 to 10 derived by equally dividing portion 13a into ten divided parts;

In-wall maldistribution degree D2=partial maldistribution degree D21 of catalyst in area 13bt on side of introduction-side cell 11 in portion 13b)−(partial maldistribution degree D22 of catalyst in area 13bb on side of discharge-side cell 12 in portion 13b);

Partial maldistribution degree D21=sum of local maldistribution degrees of catalyst of areas 1 to 5 among local maldistribution degrees of catalyst in areas 1 to 10 derived by equally dividing portion 13b into ten divided parts;

Partial maldistribution degree D22=sum of local maldistribution degrees of catalyst of areas 6 to 10 among local maldistribution degrees of catalyst in areas 1 to 10 derived by equally dividing portion 13b into ten divided parts.

As described above, the deviation of the abundance of the catalyst in the thickness direction of the partition wall 13 (the in-wall maldistribution degrees D1 and D2) is obtained for the exhaust gas introduction-side portion 13a and the exhaust gas discharge-side portion 13b, and the maldistribution degree in the present embodiment can be expressed as a difference therebetween.

Herein, the exhaust gas introduction-side portion 13a may be taken as a portion at a position of 0.15T on the inner side of the exhaust gas purifying catalyst filter 100 from the exhaust gas introduction-side end 11a (open), and the exhaust gas discharge-side portion 13b may be taken as a portion at a position of 0.15T on the inner side of the exhaust gas purifying catalyst filter 100 from the exhaust gas discharge-side end 12a (open). Herein, T indicates the total length of the exhaust gas purifying catalyst filter 100 in an extending direction. The width W of each of the portions 13a and 13b is not particularly limited as long as it is a sample width measurable with EPMA, and may be, for example, 200 to 1000 μm.

The areas 13at and 13ab of the portion 13a and the areas 13bt and 13bb of the portion 13b are respectively areas obtained by dividing the portion 13a and the portion 13b in half in a thickness direction. The area 13at of the portion 13a is an area located on the side of the introduction-side cell 11, and the area 13ab is an area located on the side of the discharge-side cell 12. Similarly, the area 13bt of the portion 13b is an area located on the side of the introduction-side cell 11, and the area 13bb is an area located on the side of the discharge-side cell 12. From the viewpoint of the flow of exhaust gas, the exhaust gas passes through the area 13at or 13bt, and then passes through the area 13ab or 13bb.

The in-wall maldistribution degree D1 expressed as the difference in the abundance of the catalyst between the areas 13at and 13ab obtained as described above serves as a value indicative of the deviation of the abundance of the catalyst in the thickness direction in the portion 13a. The in-wall maldistribution degree D1 will be described in detail. The portion 13a is equally divided into ten divided parts in a thickness direction, and abundances of the catalyst in the areas 1 to 10 are obtained. From here, an average value Ave of the abundances of the catalyst in the areas 1 to 10 is calculated, and a local maldistribution degree of each of the areas 1 to 10 is calculated.

### Example

Local maldistribution degree of area 1=((abundance of catalyst in area 1)−(average value Ave))/(average value Ave)

Local maldistribution degrees D11 of the catalyst in the area 13at (areas 1 to 5) are calculated as follows from the local maldistribution degrees in the areas 1 to 5. Similarly, partial maldistribution degrees D12 of the catalyst in the area 13ab (areas 6 to 10) are calculated as follows from the local maldistribution degrees in the areas 6 to 10. Here, except that the partial maldistribution degrees D11 and D12 are equivalent, one of the partial maldistribution degrees D11 and D12 serves as a positive value, and the other serves as a negative value.

Partial maldistribution degree D11=/(local maldistribution degrees of catalyst of areas 1 to 5)

Partial maldistribution degree D12=/(local maldistribution degrees of catalyst of areas 6 to 10)

Here, the difference between the partial maldistribution degree D11 and the partial maldistribution degree D12 is equivalent to the in-wall maldistribution degree D1, whereby the in-wall maldistribution degree D1 can be expressed by the following formula. Therefore, the in-wall maldistribution degree D1 expressed by the above formula serves as a value indicative of the deviation of the abundance of the catalyst in the thickness direction in the portion 13a. This is the same also in the in-wall maldistribution degree D2.

In-wall maldistribution degree D1=local maldistribution degree D11-local maldistribution degree D12

=Σ(local maldistribution degrees of catalyst of areas 1 to 5)−Σ(abundances of catalyst of areas 6 to 10)

=Σ(abundances of catalyst of areas 1 to 5)−(average value Ave)/(average value Ave))−

Σ((abundances of the catalyst of areas 6 to 10)−(average value Ave)/(average value Ave))

(Σ(abundances of catalyst of areas 1 to 5)−Σ(abundances of catalyst of areas 6 to 10))/average value Ave

The abundance of the catalyst in each of the areas 13at and 13ab can be obtained as an integrated value of the amount of the catalyst in each area by measuring the area of the portion 13a with EPMA, binarizing EPMA measurement data obtained by two-dimensionally mapping the presence place of the catalyst, and using the area rate of the binarized measurement data. Similarly, the abundance of the catalyst in each of the areas 13bt and 13bb can also be obtained as an integrated value of the amount of the catalyst in each area by measuring the area of the portion 13b with EPMA. The two-dimensionally mapped EPMA measurement data includes information on the abundance of the catalyst in a depth direction. Therefore, in order to evaluate appropriately the abundance of the catalyst in the measured two-dimensional cross section, as described above, it is preferable to use the area rate of the binarized measurement data to obtain an integrated value of the amount of the catalyst in each area.

In the present embodiment, the maldistribution degree of the catalyst layer formed in each wall is regulated to be 4.50 or less. The maldistribution degree of the catalyst layer formed in each wall is 4.50 or less, preferably 3.50 or less, more preferably 2.50 or less, still more preferably 1.50 or less, and yet still more preferably 1.00 or less. When the maldistribution degree of the catalyst layer is 4.50 or less, the soot collection performance of the gasoline engine exhaust gas purifying catalyst filter tends to be further improved while an increase in the pressure loss thereof is suppressed.

The WC amount of the catalyst layer in each wall is preferably 40 g/L or more and 50 g/L or less, more preferably 40 g/L or more and 49 g/L or less, and still more preferably 42 g/L or more and 46 g/L or less. When the WC amount of the catalyst layer is within the above range, a balance between the pressure loss and the soot collection performance of the gasoline engine exhaust gas purifying catalyst filter tends to be better.

(Substrate)

The wall flow type substrate 10 has a wall flow type structure where the introduction-side cell 11 having the open exhaust gas introduction-side end 11a and the discharge-side cell 12 adjacent to the introduction-side cell 11 and having the open exhaust gas discharge-side end 12a are partitioned by the porous partition wall 13.

As the substrate 10, those conventionally used for this type of application and made of various materials and forms can be used. For example, the substrate is preferably composed of heat-resistant material capable of accommodating, for example, the removal of a particulate material by high-temperature combustion as well as exposure to high-temperature (for example, 400° C. or higher) exhaust gas produced when the gasoline engine is operated under a high-load condition. Examples of the heat-resistant material include ceramics such as cordierite, mullite, aluminum titanate, and silicon carbide (SiC), and alloys such as stainless steel. The form of the substrate can be appropriately adjusted from the viewpoint of exhaust gas purifying performance and suppression of an increase in pressure loss, and the like. For example, the outer shape of the substrate may also be a cylindrical shape, an elliptical cylindrical shape, or a polygonal cylindrical shape. Depending on a space in which the substrate will be incorporated, and the like, the capacity of the substrate (total cell volume) is preferably 0.1 to 5 L, and more preferably 0.5 to 3 L. The total length of the substrate in the extending direction (the total length of the partition wall 13 in the extending direction) is preferably 10 to 500 mm, and more preferably 50 to 300 mm.

The introduction-side cell 11 and the discharge-side cell 12 are regularly arranged along the axis direction of the cylindrical shape. For cells adjacent to each other, the open end of one in the extending direction and the open end of another one are alternately sealed off. The introduction-side cell 11 and the discharge-side cell 12 can be set to a suitable shape and size in consideration of the flow rate and components of the exhaust gas to be supplied. For example, the opening shape of the introduction-side cell 11 and discharge-side cell 12 may be a triangle; a rectangular shape such as a square, a parallelogram, a rectangle, or a trapezoid; other polygon such as a hexagon or an octagon; and a circle. The exhaust gas purifying catalyst filter 100 may have a high ash capacity (HAC) structure where the cross-sectional area of the introduction-side cell 11 and the cross-sectional area of the discharge-side cell 12 are made different from each other.

The number of the introduction-side cells 11 and the number of the discharge-side cells 12 can be appropriately set so that the occurrence of the turbulent flow of the exhaust gas can be promoted and clogging due to fine particles and the like contained in the exhaust gas can be suppressed. The number of the introduction-side cells 11 and the number of the discharge-side cells 12 are not particularly limited, and preferably 200 cpsi to 400 cpsi. The thickness of the partition wall 13 (a length in a thickness direction perpendicular to the extending direction) is preferably 6 to 12 mil, and more preferably 6 to 10 mil.

The partition wall 13 partitioning the cells adjacent to each other is not particularly limited as long as the partition wall 13 has a porous structure through which the exhaust gas can pass. The constitution of the partition wall 13 can be appropriately adjusted from the viewpoint of exhaust gas purifying performance, suppression of an increase in pressure loss, and improvement in the mechanical strength of a substrate, and the like. For example, when the catalyst layer 21 is formed on the surface of the pore in the partition wall 13 using a catalyst slurry to be described later, and a pore diameter (for example, modal diameter (the pore diameter having the largest appearance ratio in the frequency distribution of the pore diameter (maximum value of distribution))) and a pore volume are large, the blockage of the pore due to the catalyst layer 21 is less likely to occur, and the exhaust gas purifying catalyst filter to be obtained tends to be less likely to cause an increase in pressure loss. However, the collection ability of the particulate material tends to be reduced, and the mechanical strength of the substrate tends to be also reduced. Meanwhile, when the pore diameter and the pore volume are small, the pressure loss is likely to be increased. However, the collection ability of the particulate material tends to be improved, and the mechanical strength of the substrate tends to be also improved.

(Catalyst Layer)

Next, the catalyst layer 21 formed in the pore of the partition wall 13 will be described. The catalyst layer 21 in the present embodiment is a single layer composed of a catalyst metal and a carrier component, and is free of Ba. In the catalyst layer 21, it is preferable that the catalyst metal is Pd and/or Rh, and the carrier component is Al oxide, Zr oxide, and/or Ce oxide.

Examples of the catalyst layer 21 include a catalyst layer obtained by firing a catalyst slurry containing predetermined catalyst metal particles and predetermined carrier particles. Thus, the catalyst layer 21 formed by firing the catalyst slurry containing various particles has a microporous structure in which the particles adhere to each other by firing.

The catalyst metal contained in the catalyst layer 21 is preferably palladium (Pd) and/or rhodium (Rh). Among these, from the viewpoint of oxidation activity, palladium (Pd) is preferable, and from the viewpoint of reduction activity, rhodium (Rh) is preferable. A synergistic effect provided by different catalyst activities is expected by the combination use of these two types of catalyst metals.

The catalyst layers 21 containing the catalyst metals can be confirmed by observing the cross section of the partition wall 13 of the exhaust gas purifying catalyst filter 100 with a scanning electron microscope and the like. Specifically, it can be confirmed by subjecting the field of view of the scanning electron microscope to energy dispersive X-ray analysis. The carrier component is preferably Al oxide, Zr oxide, and/or Ce oxide, and the catalyst layer is free of Ba.

Carrier particles contained in the catalyst layer 21 and supporting the catalyst metals are Al oxide, Zr oxide, and/or Ce oxide. Examples of such oxides include, but are not particularly limited to, oxygen storage capacity materials (OSC materials) such as cerium oxide (ceria: CeO₂) and ceria-zirconia composite oxide (CZ composite oxide), oxides such as aluminum oxide (alumina: Al₂O₃) and zirconium oxide (zirconia: ZrO₂), and composite oxides mainly containing the oxides. These may be composite oxides or solid solutions containing rare earth elements such as lanthanum and yttrium, and transition metal elements. These carrier particles may be used alone or in combination of two or more. Herein, the oxygen storage capacity material (OSC material) stores oxygen in the exhaust gas when the air-fuel ratio of the exhaust gas is lean (that is, an atmosphere on the oxygen excess side), and releases the stored oxygen when the air-fuel ratio of the exhaust gas is rich (that is, an atmosphere on the fuel excess side).

### [Method for Producing Exhaust Gas Purifying Catalyst Filter]

A producing method of the present embodiment is a method for producing an exhaust gas purifying catalyst filter 100 for purifying exhaust gas discharged from a gasoline engine. The method includes: a step S0 of preparing a wall flow type substrate 10 in which an introduction-side cell 11 having an open exhaust gas introduction-side end 11a, and a discharge-side cell 12 adjacent to the introduction-side cell 11 and having an open exhaust gas discharge-side end 12a are defined by a porous partition wall 13; and a catalyst layer forming step S1 of forming a catalyst layer 21 by coating a catalyst slurry on at least a part of the surface of a pore in the partition wall 13 of the wall flow type substrate 10. In the catalyst layer forming step S1, the absolute value of the maldistribution degree of the catalyst layer formed in the pore of the partition wall of the wall flow type substrate is 4.50 or less. The wash coat amount of the catalyst layer excluding a mass of a platinum group per 1 L of the wall flow type substrate is 40 g/L or more and 50 g/L or less. The catalyst layer 21 formed in the pore of the partition wall 13 is a single layer, and is composed of a catalyst metal and a carrier component. The catalyst metal is Pd and/or Rh, and the carrier component is Al oxide, Zr oxide, and/or Ce oxide. The catalyst layer 21 is free of Ba.

Hereinafter, each of the steps will be described. Herein, a wall flow type substrate before the catalyst layers 21 are formed is represented as “substrate 10”, and a wall flow type substrate after the catalyst layers 21 are formed is represented as “exhaust gas purifying catalyst filter 100.”

### <Preparing Step>

In the preparing step S0, the wall flow type substrate 10 described in the above exhaust gas purifying catalyst filter 100 is prepared as a substrate.

### <Catalyst Layer Forming Step>

In the catalyst layer forming step S1, a catalyst slurry is coated on the surface of the pores in the partition wall 13, followed by drying and firing, to form the catalyst layers 21. The method for coating the catalyst slurry is not particularly limited, and examples thereof include a method in which a part of the substrate 10 is impregnated with the catalyst slurry, to spread the catalyst slurry over the entire partition wall 13 of the substrate 10. More specific examples thereof include a method including an impregnating step S1a of impregnating the exhaust gas introduction-side end 11a or the exhaust gas discharge-side end 12a with a catalyst slurry containing ammonium carbonate, a coating step S1b of introducing gas into the substrate 10 from the side of the end impregnated with the catalyst slurry to coat the catalyst slurry with which the substrate 10 is impregnated on the partition wall 13, a drying step S1c of drying the coated catalyst slurry, and a firing step S1d of firing the coated catalyst slurry.

The impregnation method of the catalyst slurry in the impregnating step S1a is not particularly limited, and examples thereof include a method in which an end of the substrate 10 is immersed in the catalyst slurry. In the method, the catalyst slurry may be pulled up by discharging (suctioning) gas from its opposite end if needed. The end impregnated with the catalyst slurry may be either the exhaust gas introduction-side end 11a or the exhaust gas discharge-side end 12a.

In the coating step S1b, the catalyst slurry moves along with the flow of gas F from the introduction side of the substrate 10 toward the innermost part thereof, and reaches to the discharge-side end of the gas F. In the process, the catalyst slurry passes through the pore of the partition wall 13, whereby the inside of the pore can be coated with the catalyst slurry, and the whole partition wall is coated with the catalyst slurry.

In drying step S1c, the coated catalyst slurry is dried. The drying condition in the drying step S1c is not particularly limited as long as a solvent is volatilized from the catalyst slurry. For example, a drying temperature is preferably 100 to 225° C., more preferably 100 to 200° C., and still more preferably 125 to 175° C. A drying time is preferably 0.5 to 2 hours, and more preferably 0.5 to 1.5 hours.

In the firing step S1d, the catalyst slurry is fired, to form the catalyst layers 21. A firing condition in the firing step S1d is not particularly limited as long as the catalyst layers 21 can be formed from the catalyst slurry. For example, a firing temperature is not particularly limited, and preferably 400 to 650° C., more preferably 450 to 600° C., and still more preferably 500 to 600° C. A firing time is preferably 0.5 to 2 hours, and more preferably 0.5 to 1.5 hours.

(Catalyst Slurry)

The catalyst slurry for forming the catalyst layers 21 will be described. The catalyst slurry contains ammonium carbonate, a catalyst powder and a solvent such as water. The catalyst powder is a population of a plurality of catalyst particles containing catalyst metal particles and carrier particles supporting the catalyst metal particles, and the catalyst layers 21 are formed through a firing step to be described later. The catalyst particles are not particularly limited, and can be appropriately selected to be used from known catalyst particles. From the viewpoint of the coatability into the pores in the partition wall 13, the solid content rate of the catalyst slurry is preferably 1 to 50% by mass, more preferably 15 to 40% by mass, and still more preferably 20 to 35% by mass. By the solid content rate, the catalyst slurry tends to be readily coated on the side of the introduction-side cell 11 in the partition wall 13.

The D90 particle size of the catalyst powder contained in the catalyst slurry is preferably 1 to 8 μm, more preferably 1 to 6 μm, and still more preferably 1 to 4 μm. When the D90 particle size is 1 μm or more, a pulverization time when the catalyst powder is ground in a milling apparatus can be shortened, which tends to provide further improved work efficiency. When the D90 particle size is 8 μm or less, the blockage of the pores in the partition wall 13 by coarse particles is suppressed, which tends to suppress an increase in pressure loss. Herein, the D90 particle size can be measured with a laser diffraction particle size analyzer (for example, a laser diffraction particle size analyzer SALD-3100, manufactured by Shimadzu Corporation, and the like).

The catalyst metals contained in the catalyst slurry are not particularly limited, and various metal species which can function as oxidation catalysts and reduction catalysts can be used. Examples thereof include palladium (Pd) and rhodium (Rh). Among these, from the viewpoint of oxidation activity, palladium (Pd) is preferable, and from the viewpoint of reduction activity, rhodium (Rh) is preferable.

Inorganic compounds heretofore used for this type of exhaust gas purifying catalyst filter can be considered as carrier particles supporting the catalyst metal particles. Examples thereof include oxygen storage capacity materials (OSC materials) such as cerium oxide (ceria: CeO₂) and ceria-zirconia composite oxide (CZ composite oxide), oxides such as aluminum oxide (alumina: Al₂O₃) and zirconium oxide (zirconia: ZrO₂), and composite oxides mainly containing the oxides. These may be composite oxides or solid solutions containing rare earth elements such as lanthanum and yttrium, and transition metal elements. These carrier particles may be used alone or in combination of two or more. Herein, the oxygen storage capacity material (OSC material) stores oxygen in the exhaust gas when the air-fuel ratio of the exhaust gas is lean (that is, an atmosphere on the oxygen excess side), and releases the stored oxygen when the air-fuel ratio of the exhaust gas is rich (that is, an atmosphere on the fuel excess side). From the viewpoint of exhaust gas purifying performance, the specific surface area of the carrier particles contained in the catalyst slurry is preferably 10 to 500 m²/g, and more preferably 30 to 200 m²/g.

### [Application]

An air-fuel mixture containing oxygen and fuel gas is supplied into the gasoline engine (engine), where the air-fuel mixture is burned to convert combustion energy into mechanical energy. At this time, the burned air-fuel mixture becomes exhaust gas and is discharged to the exhaust system. An exhaust gas purifying apparatus including an exhaust gas purifying catalyst filter is provided in the exhaust system. The exhaust gas purifying catalyst filter purifies harmful components (for example, carbon monoxide (CO), hydrocarbon (HC), and nitrogen oxides (NOₓ)) contained in the exhaust gas, and collects and removes a particulate material (PM) contained in the exhaust gas. In particular, the exhaust gas purifying catalyst filter 100 of the present embodiment is preferably used for a gasoline particulate filter (GPF) which can collect and remove the particulate material contained in the exhaust gas of the gasoline engine.

### EXAMPLES

Hereinafter, the features of the present invention will be described further specifically by way of Test Examples, Examples, and Comparative Examples, but the present invention is in no way limited thereto. That is, materials, used amounts, ratios, treatment contents, and treatment procedures and the like shown in the following Examples can be appropriately changed without departing from the spirit of the present invention. Various values specified in the following Examples for production conditions and evaluation results have meaning as preferable upper limits or preferable lower limits in embodiments of the present invention, and a preferable range may be defined by a combination of the upper or lower limit described above and a value specified in one of the following Examples or values specified in different Examples.

### Example 1

An alumina powder was impregnated with an aqueous solution of palladium nitrate, and then fired at 500° C. for 1 hour, to obtain a Pd-supporting powder. An alumina zirconia composite oxide powder was impregnated with an aqueous solution of rhodium nitrate, and then fired at 500° C. for 1 hour, to obtain a Rh-supporting powder.

1.0 kg of the obtained Pd-supporting powder, 1.0 kg of the Rh-supporting powder, 1.0 kg of a ceria zirconia composite oxide powder, 190 g of an aqueous solution of 23% lanthanum nitrate, 60% nitric acid, and ion exchange water were mixed to obtain a mixture. The mixture was charged into a ball mill, where the predetermined particle size distribution (D90 particle size: 3.0 μm) of a catalyst powder was set, and 44 g of ammonium carbonate was then charged to obtain a catalyst slurry.

Then, a wall flow type honeycomb substrate was prepared, which was made of cordierite (number of cells/mil thickness: 300 cpsi/8.5 mil, diameter: 118.4 mm, total length: 127 mm, pore diameter (median size): 20 μm, porosity: 63%). By immersing an exhaust gas introduction-side end of the substrate in a catalyst slurry, and subjecting the side of its opposite end to reduced-pressure suction, the catalyst slurry was impregnated and retained in a substrate end. Gas was caused to flow into the substrate from the exhaust gas introduction-side end, to coat the catalyst slurry on the surface of a pore in a partition wall, and to blow off the excess catalyst slurry from an exhaust gas discharge-side end of the substrate, thereby stopping the inflow of the gas. Then, the substrate on which the catalyst slurry was coated was dried at 150° C., and then fired at 550° C. in an air atmosphere to produce an exhaust gas purifying catalyst filter. The WC amount of a catalyst layer after firing was 44 g per 1 L of the substrate (excluding the mass of a platinum group metal).

### Example 2

An exhaust gas purifying catalyst filter was prepared in the same manner as in Example 1 except that the WC amount of a catalyst layer to a partition wall of a wall flow type honeycomb substrate was changed. The WC amount of the catalyst layer after firing was 49 g per 1 L of the substrate (excluding the mass of a platinum group metal).

### Example 3

prepared in the same manner as in Example 1 except that the WC amount of a catalyst layer to a partition wall of a wall flow type honeycomb substrate was changed. The WC amount of the catalyst layer after firing was 40 g per 1 L of the substrate (excluding the mass of a platinum group metal).

### Comparative Example 1

An exhaust gas purifying catalyst filter was prepared in the same manner as in Example 1 except that ammonium carbonate was not charged in the producing process of a catalyst slurry. The WC amount of a catalyst layer after firing was 44 g per 1 L of a substrate (excluding the mass of a platinum group metal).

### Comparative Example 2

An exhaust gas purifying catalyst filter was prepared in the same manner as in Comparative Example 1 except that the WC amount of a catalyst layer to a partition wall of a wall flow type honeycomb substrate was changed. The WC amount of the catalyst layer after firing was 61 g per 1 L of the substrate (excluding the mass of a platinum group metal).

### Comparative Example 3

An exhaust gas purifying catalyst filter was prepared in the same manner as in Example 1 except that the WC amount of a catalyst layer to a partition wall of a wall flow type honeycomb substrate was changed. The WC amount of the catalyst layer after firing was 61 g per 1 L of the substrate (excluding the mass of a platinum group metal).

### [Measurement of Particle Size Distribution]

The D90 particle size of the catalyst slurry was measured by a laser scattering method using a laser diffraction particle size analyzer SALD-3100 manufactured by Shimadzu Corporation.

### [Measurement of Maldistribution Degree of Catalyst Layer in Partition Wall]

The presence or absence of the catalyst layer in the partition wall of the gasoline engine exhaust gas purifying catalyst filter prepared in each of Examples and Comparative Examples was measured using an electron probe micro analyzer (EPMA) JXA-8100 manufactured by JEOL, to calculate a maldistribution degree from the obtained two-dimensional data.

### [Measurement of Pressure Loss]

The exhaust gas purifying catalyst filter prepared in each of Examples and Comparative Examples and the substrate before the catalyst slurry was applied were set in a pressure loss measuring device (manufactured by Tsukubarikaseiki Corporation), and air having room temperature was introduced into the set exhaust gas purifying catalyst filter. A value obtained by measuring a differential pressure of the air on introduction and discharge sides when the discharge amount of the air from the exhaust gas purifying catalyst filter was 4 m³/min was taken as the pressure loss of the exhaust gas purifying catalyst filter.

[Measurement of Soot Collection performance]

The exhaust gas purifying catalyst prepared in each of Examples and Comparative Examples was attached to a vehicle equipped with a 1.5 L direct-injection turbocharged engine, and the number of emitted soot particles during WLTC mode driving (PNₜₑₛₜ) was measured using a solid particle counting system (manufactured by HORIBA Ltd., product name: MEXA-2100 SPCS). The soot collection rate was calculated in terms of a decrease expressed in percentage from the amount of soot measured when the above test was carried out without attaching an exhaust gas purifying catalyst filter (PN_{blank}) according to the following formula:

Soot collection rate (%)=(PN_{blank}−PNₜₑₛₜ)/PN_{blank}×100(%)

The results are shown below.

TABLE 1

| | Maldistribution | | | | |
|---|---|---|---|---|---|
| | degree of | WC | | | |
| | catalyst layer | amount | Soot | Pressure | Com- |
| | (absolute | of catalyst | collection | loss | prehensive |
| | value) | layer (g/L) | rate (%) | (kPa) | evaluation |
| Example 1 | 0.16 | 44 | 62.8 | 1.18 | Excellent |
| | | | | | (O) |
| Example 2 | 0.10 | 49 | 64.2 | 1.25 | Excellent |
| | | | | | (O) |
| Example 3 | 0.95 | 40 | 58.2 | 1.15 | Excellent |
| | | | | | (O) |
| Com- | 6.65 | 44 | 49.9 | 1.08 | Poor |
| parative | | | | | (X) |
| Example 1 | | | | | |
| Com- | 6.73 | 61 | 51.0 | 1.18 | Poor |
| parative | | | | | (X) |
| Example 2 | | | | | |
| Com- | 1.17 | 61 | 69.4 | 1.42 | Poor |
| parative | | | | | (X) |
| Example 3 | | | | | |

As described above, in Examples, the maldistribution degree of the catalyst layer is equal to or less than a predetermined value, and the WC amount of the catalyst layer is within a predetermined value, whereby improvement in the soot collection rate is achieved while an increase in the pressure loss is suppressed. In Comparative Examples, the pressure loss increases or the soot collection rate decreases.

### INDUSTRIAL APPLICABILITY

An exhaust gas purifying catalyst filter of the present invention removes a particulate material contained in exhaust gas of a gasoline engine, whereby the exhaust gas purifying catalyst filter can be widely and effectively utilized.

### REFERENCE SIGNS LIST

10 . . . wall flow type substrate
11 . . . introduction-side cell
11a . . . exhaust gas introduction-side end
12 . . . discharge-side cell
12a . . . exhaust gas discharge-side end
13 . . . partition wall
21 . . . catalyst layer
100 . . . exhaust gas purifying catalyst filter

1. A gasoline engine exhaust gas purifying catalyst filter for purifying exhaust gas of a gasoline engine, comprising:
a wall flow type substrate in which an introduction-side cell having an open exhaust gas introduction-side end, and a discharge-side cell adjacent to the introduction-side cell and having an open exhaust gas discharge-side end are defined by a porous partition wall; and
a catalyst layer formed in a pore of the partition wall,
wherein an absolute value of a maldistribution degree of the catalyst layer formed in the pore of the partition wall is 4.50 or less;
a wash coat amount, excluding a mass of a platinum group, of the catalyst layer formed in the pore of the partition wall is 40 g/L or more and 50 g/L or less;
the catalyst layer formed in the pore of the partition wall is a single layer; and
the catalyst layer is free of Ba.

2. The gasoline engine exhaust gas purifying catalyst filter according to claim 1,
wherein the catalyst layer formed in the pore of the partition wall contains a catalyst metal and a carrier component; the catalyst metal is Pd and/or Rh; and the carrier component is Al oxide, Zr oxide, and/or Ce oxide.

3. A method for producing a gasoline engine exhaust gas purifying catalyst filter for purifying exhaust gas of a gasoline engine, the method comprising:
the step of preparing a wall flow type substrate in which an introduction-side cell having an open exhaust gas introduction-side end, and a discharge-side cell adjacent to the introduction-side cell and having an open exhaust gas discharge-side end are defined by a porous partition wall;
impregnating step of impregnating the exhaust gas introduction-side or exhaust gas discharge-side end of the wall flow type substrate with a catalyst slurry containing ammonium carbonate;
coating step of introducing gas into the wall flow type substrate from a side of the end impregnated with the catalyst slurry to coat the catalyst slurry with which the wall flow type substrate is impregnated on a surface of a pore of the partition wall; and
firing step of firing the coated catalyst slurry to obtain an exhaust gas purifying catalyst filter in which an absolute value of a maldistribution degree of a catalyst layer formed in the pore of the partition wall is 4.50 or less, and a wash coat amount of the catalyst layer, excluding a mass of a platinum group per 1 L of the wall flow type substrate, is 40 g/L or more and 50 g/L or less,
wherein:
the catalyst layer formed in the pore of the partition wall is a single layer; and
the catalyst layer is free of Ba.

4. The method for producing a gasoline engine exhaust gas purifying catalyst filter according to claim 3, further comprising
the step of measuring the catalyst layer in the pore of the partition wall of the exhaust gas purifying catalyst filter with an electron probe micro analyzer, to inspect the absolute value of the maldistribution degree of the catalyst layer after the firing step of obtaining the exhaust gas purifying catalyst filter.
